(19) United States
(12) Patent Application Publication
(10) Pub. No.: US 2003/0023785 A1
(43) Pub. Date: Jan. 30, 2003

(54) Data processing program, computer readable recording medium recorded with data processing program and data processing apparatus

(75) Inventors: Yoshikazu Funato, Nagoya (JP); Makoto Uchida, Kahoku-gun (JP); Akira Hayakawa, Kahoku-gun (JP); Kiyomi Ozawa, Maebashi (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 09/994,789

(22) Filed: Nov. 28, 2001

(30) Foreign Application Priority Data
Jul. 30, 2001 (JP) 2001-229423

(51) Int. Cl. G06F 3/00

(52) U.S. Cl. 710/38

(57) ABSTRACT

A data processing program, a computer readable recording medium recorded with the data processing program and a data processing apparatus, capable of facilitating the modification of process paths and improving the processing power by dynamically modifying the process paths for various modules at the need arises.

### FIELD OF THE INVENTION

The present invention relates to a data processing technology for performing a series of data processing by combining various modules, and especially to a technology for improving processing power while facilitating the modification of data process paths.

### RELATED ART OF THE INVENTION

In the information processing field, there has been known a concept “module” in which various apparatuses, circuits, memories, and programs are divided into each function unit, so that the addition, deletion and modification can be easily executed. As an application technology of the module, for example, as disclosed in Japanese Unexamined Patent Publication No. 11-39269, a data processing apparatus has been developed for performing a series of data processing by combining various modules.

In this data processing apparatus, process sequence information including a process order number, module identification information, and so forth are added to the data to be processed in order to set flows of data (process paths) among the modules). In the module which has received the data to be processed, the data processing is performed based on the process sequence information, as well as the data to be processed is sent to a module which is to perform the data processing next.

In a conventional data processing apparatus, however, the process order number should be attached even to the data not requiring the process order. Therefore, when a load of a specific module is increased, there is a possibility that a bottleneck is caused, resulting in lowering the processing power. Further, when there is a plurality of modules each having the same function, there is a possibility that the processing power is lowered depend on which module is designated. Moreover, when a new module is added for strengthening a module function, the process sequence information is required to be largely modified, resulting in the large effort necessary for the modification of the process paths.

The present invention, in view of the forgoing problems, has an object of providing a data processing technology in which the processing power is improved while facilitating the modification of process paths by dynamically modifying the process paths at the need arises.

### SUMMARY OF THE INVENTION

For this purpose, with a data processing technology according to the present invention, process paths are set for various modules and, based on the set process paths, a control for transferring data to be processed among the various modules is performed, and, on the other hand, the set process paths are dynamically modified at the need arises. At this time, the process paths are dynamically modified by adding a module necessary for the data processing in the various modules or by deleting a module that has become unnecessary as a result of data processing in the various modules. The dynamic modification of the process paths may be executed when the data processing is performed in the module capable of judging the necessity of modification or when the control of transferring the data to be processed is carried out.

According to this constitution, in normal data processing, the control of transferring the data to be processed among the various modules is performed based on the set process paths. On the other hand, when there is a module necessary for the data processing in the various modules or there is a module that has become unnecessary as a result of data processing in the various modules, the set process paths are dynamically modified. Accordingly, for the data which does not require the process order, a bottleneck can be avoided to improve the processing power by, for example, giving priority to the processing in the module with less load corresponding to the processing situation of each of the various modules included in the process paths. Moreover, for example, even when a new module is added for strengthening a module function, since a process path is added to the added module at the need arises, the modification of the process path can be easily made. Further, when a process path to a module not requiring the data processing is included, since the process path to this module is deleted, a passage to a module that does not influence a data processing result at all is avoided. From this standpoint, the processing power can also be improved.

The process path for each of the various modules may be set by referring to a table corresponding to a process content of the data to be processed. In this way, a load required for setting a process path is lowered, and as a result, the response speed, the maintenance performance and the like can be improved.

Further, for the process path, the path designation for designating the process order of the module, the processing section designation for designating the module only, and the compound designation combining the path designation and the processing section designation may be selectively made. In this way, it becomes possible to flexibly cope with various data processing and the general use of the data processing technology is made.

The other objects and features of this invention will be become understood from the following description with accompanying drawings.

### BRIEF EXPLANATION OF THE DRAWINGS

FIG. 1 is a structural diagram of a system for controlling the network traffic intelligently by the present invention.

FIG. 2 is an explanatory diagram of a table managed by a policy managing section.

FIG. 3 shows a designation method of the process order, wherein FIG. 3A is an explanatory diagram of a path designation method, FIG. 3B is an explanatory diagram of a processing section designation method, and FIG. 3C is an explanatory diagram of a compound designation method.

FIG. 4 is a flowchart showing a process content at a path information setting section.

FIG. 5 is an explanatory diagram of frame data.

FIG. 6 is a flowchart showing a process content at a control section.

FIG. 7 is a flowchart showing a process content at each of various modules.

FIG. 8 shows a first example processing an access demand to a mirror server, wherein FIG. 8A is an explanatory diagram of a data flow and FIG. 8B is an explanatory diagram of the process sequence.

FIG. 9 is an explanatory diagram of a frame data content in the first example.

FIG. 10 shows a second example processing an access demand to Internet, wherein FIG. 10A is an explanatory diagram of a data flow and FIG. 10B is an explanatory diagram of the process sequence.

FIG. 11 is an explanatory diagram of a frame data content in the second example.

FIG. 12 shows a third example processing a connection demand to a remote site, wherein FIG. 12A is an explanatory diagram of a data flow and FIG. 12B is an explanatory diagram of the process sequence.

FIG. 13 is an explanatory diagram of a frame data content in the third example.

### PREFERRED EMBODIMENT

The present invention will be explained in detail with reference to the accompanying drawings.

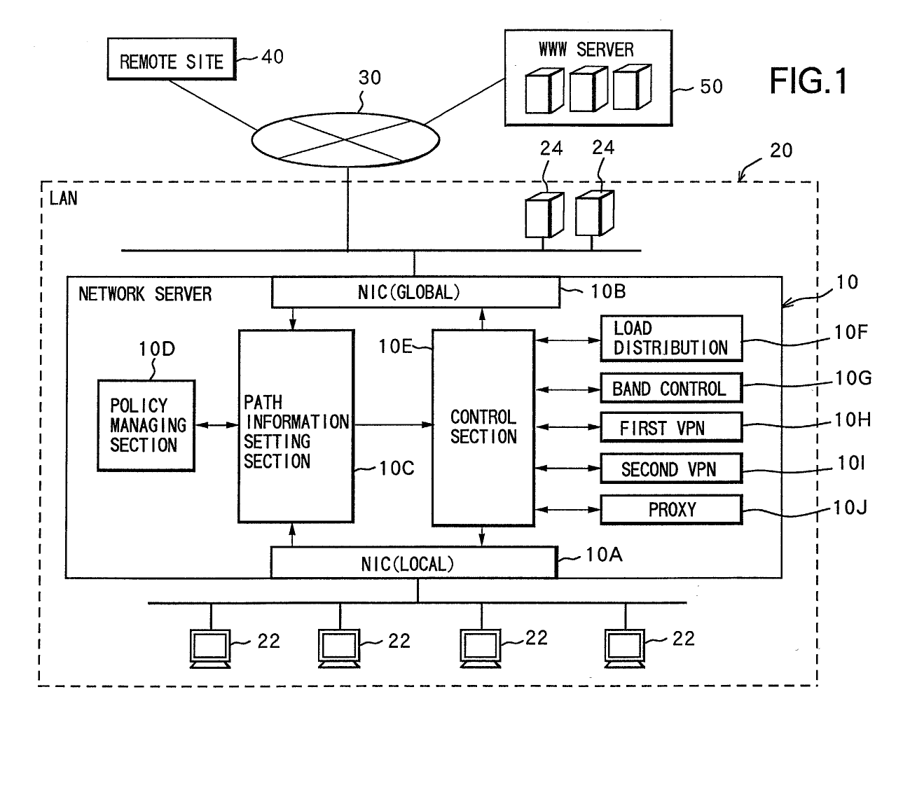

FIG. 1 shows a system structure controlling the network traffic intelligently using a network server applied with a data processing technology according to the invention. The network server is constructed on a computer including at least a central processing unit (CPU) and a memory, and programs loaded in the memory realize various functions. In the following explanation, a network interface card being a peripheral device connecting the computer with the network is written as NIC and a virtual private network being a dedicated network constructed virtually is written as VPN.

LAN (Local Area Network) 20 constructed using a network server 10 is connected to a remote site 40 and to a WWW (World Wide Web) server 50 respectively, via the Internet 30 as VPN. In LAN 20, the network server 10, clients 22 and mirror servers 24 are mutually connected through a local line such as Ethernet.

The network server 10 includes NIC (local) 10A, NIC (global) 10B, a path information setting section 10C, a policy managing section 10D, and a control section 10E, and also includes a load distribution 10F, a band control 10G, a first VPN 10H, a second VPN 10I and a proxy 10J, respectively exhibiting functions as various modules. Here, “module” is one in which various apparatuses, circuits, memories, and programs are divided into each function unit, so that the addition, deletion and modification can be easily executed.

The path information setting section 10C realizes a path information setting function and path information setting means. Further, the control section 10E realizes a control function, control means, a process path modifying function, and process path modifying means. Moreover, the various modules 10F to 10J realize the process path modifying function and the process path modifying means.

At NIC (local) 10A, the interface with the clients 22 is performed. At NIC (global) 10B, the interface with the mirror servers 24 and with Internet 30 is performed. At the path information setting section 10C, a table managed by the policy managing section 10D is referred to and frame data in which data to be processed is added with path information is created. Here, “path information” means information setting a path for processing in each of the various modules (the details thereof will be described later).

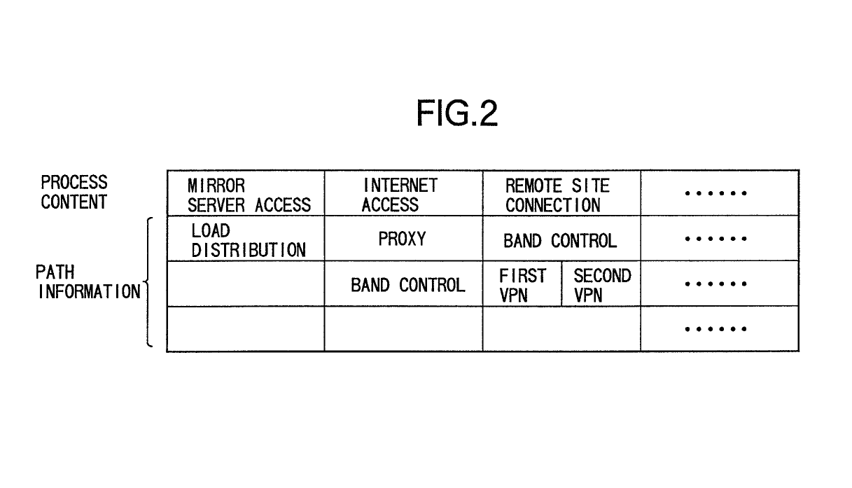

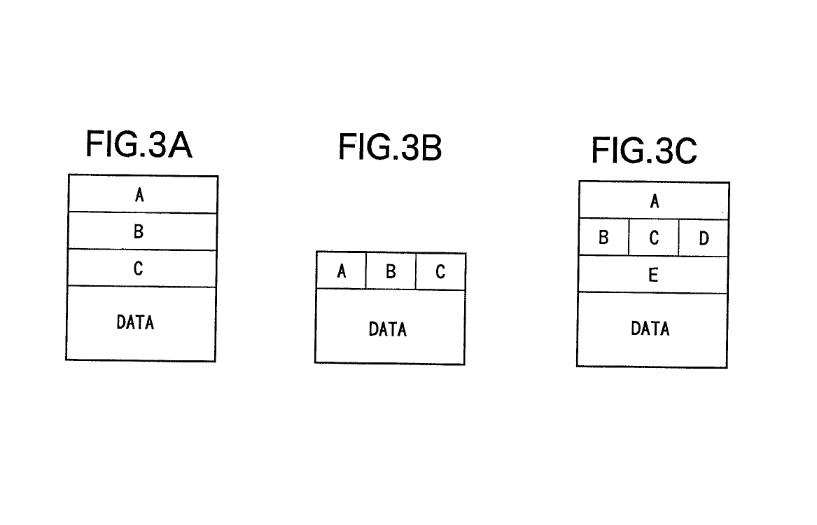

At the policy managing section 10D, as shown in FIG. 2, the path information corresponding to data processing contents is managed. The path information is composed so as to enable to selectively designate “the path designation” for designating the process order of the various modules (refer to FIG. 3A), “the processing section designation” for designating the module only (refer to FIG. 3B), and “the compound designation” combining the path designation and the processing section designation (refer to FIG. 3C). Here, at “the path designation”, data process paths having the order are treated and at “the processing section designation”, data process paths not having the order are treated. In this way, it becomes possible to flexibly cope with various data processing and the general use of the data processing technology is made.

At the control section 10E, based on the path information included in the frame data, the frame data are selectively transferred among the various modules. At the load distribution 10F, a demand from the client 22 is forwarded to the appropriate mirror server 24 in order to distribute a load. At the band control 10G, a network band is controlled through a classification and a control of the network traffic corresponding to a service content or a task content. At the first VPN 10H and the second VPN 10I, the network traffic to VPN is controlled, respectively. At the proxy 10J, conversion processing is performed between a local IP (Internet Protocol) address and a global IP address is performed.

Next, functions of the path information setting section 10C, the control section 10E and each of the various modules 10F to 10J will be described.

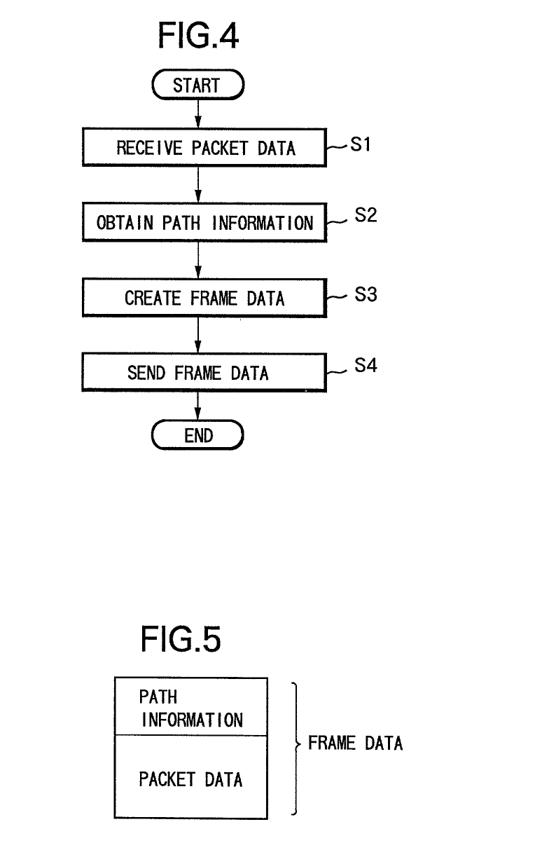

FIG. 4 shows process contents to be executed at the path information setting section 10C when NIC (local) 10A has received packet data from the client 22.

At Step 1 (abbreviated as “S1” in the drawing, the same holds hereinafter), the packet data forwarded from NIC (local) 10A is received.

At Step 2, a table managed by the policy managing section 10D is referred to and the path information adapted for the content of the packet data is obtained.

At Step 3, as shown in FIG. 5, the frame data in which the path information is added to the packet data is created.

The procedures of Step 2 and Step 3 correspond to the process path setting function and the process path setting means.

At Step 4, the frame data created is sent to the control section 10E.

According to the procedures of Step 1 to Step 4, at the path information setting section 10C, the frame data in which the packet data being the data to be processed is added with the path information corresponding to the content thereof is created. The created frame data is sent to the control section 10E to perform a series of data processing corresponding to the path information. Therefore, only by modifying the table to be managed by the policy managing section 10D, the process path can be easily added, deleted or modified. As a result, effort necessary for the modification of the process paths can be reduced remarkably.

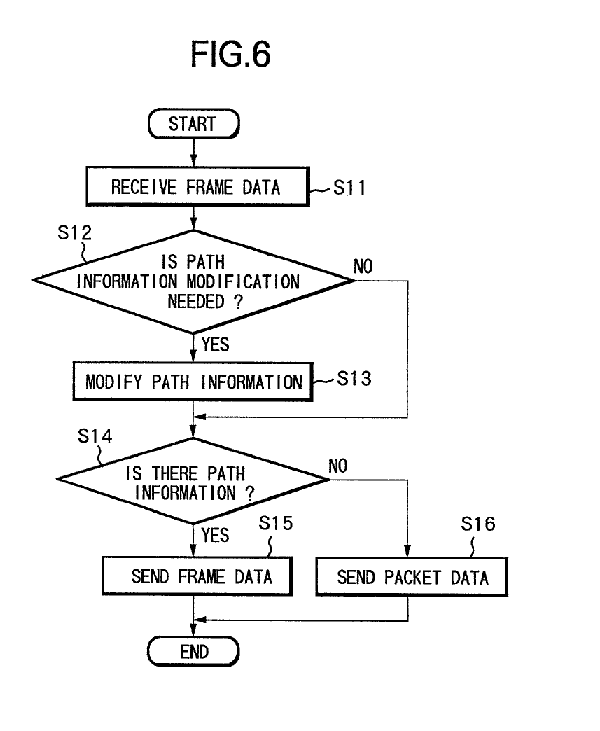

FIG. 6 shows the process contents to be executed at the control section 10E following the process at the path information setting section 10C.

At Step 11, the frame data sent from the path information setting section 10c is received.

At Step 12, it is judged whether or not the modification of the path information in the frame data is necessary. Namely, with regard to the data processing in a certain module, for example, when the process in another module that is not included in the path information is required, a process path to this module is added. If the modification of the path information is necessary (Yes), the path information is dynamically modified at Step 13. On the contrary, if the modification of the path information is not necessary (No), the procedure advances to Step 14. The modification of the path information will be apparent from an embodiment described later.

The procedures of Step 12 and Step 13 correspond to the process path modifying function and the process path modifying means.

At Step 14, it is judged whether or not the path information is in the frame data, namely, there is a module to be processed next. If the path information is in the frame data (Yes), at Step 15, the frame data is sent to the module to be processed next. On the contrary, if the path information is not in the frame data (No), it is judged that all of the data processing is completed, and at Step 16, the packet data is sent to NIC (global) 10B.

The procedures of Step 14 to Step 16 correspond to the control function and the control means.

According to the procedures of Step 11 to Step 16, when the frame data is received at the control section 10E, the modification of the path information is made at the need arises. When there is the path information, the frame data is sent to the module to be processed next, while there is not the path information, it is judged that all of the data processing is completed, and the packet data is sent to NIC (global) 10B. Therefore, since the path information set at the path information setting section 10C is dynamically modified corresponding to, for example, the processing situation of each of the various modules, the reduction of the processing power due to a bottleneck and the like can be restrained.

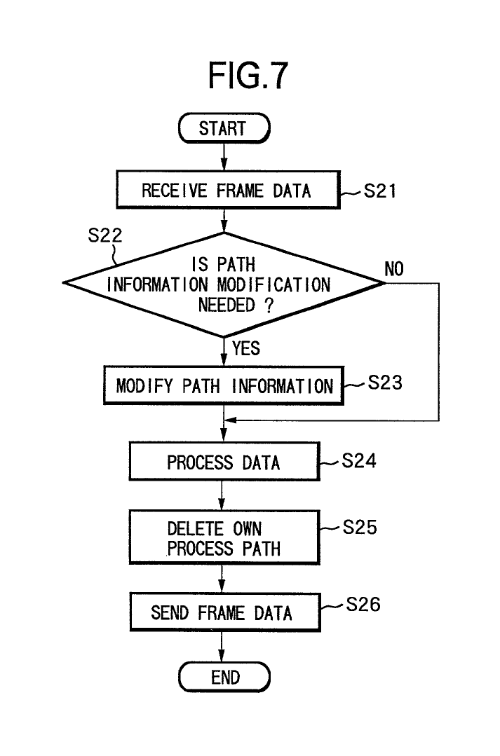

FIG. 7 shows process contents to be executed at each of the various modules 10F to 10J.

At Step 21, the frame data sent from the control section 10E is received.

At Step 22, it is judged whether or not the modification of the path information in the frame data is necessary. If the modification of the path information is necessary (Yes), the path information is modified at Step 23, while if the modification of the path information is not necessary (No), the procedure advances to Step 24. The procedures of Step 22 and Step 23 correspond to the process path modifying function and the process path modifying means.

At Step 24, the data processing peculiar to module is performed to the packet data in the frame data.

At Step 25, a process path to the own module is deleted from the path information in the frame data.

At Step 26, the frame data is sent to the control section 10E.

According to Step 21 to Step 26, when the frame data is received at each of the various modules 10F to 10J, the modification of the path information is performed at the need arises. After the data processing peculiar to module is performed, the frame data from which the process path in the own module is deleted is sent to the control section 10E. Therefore, even when a plurality of modules exhibiting the same function are provided at the path information setting section 10C, since the process path not requiring the process is dynamically deleted, the reduction of the processing power can be restrained.

Next, an operation of a data processing apparatus having such a constitution will be described clearly with reference to examples.

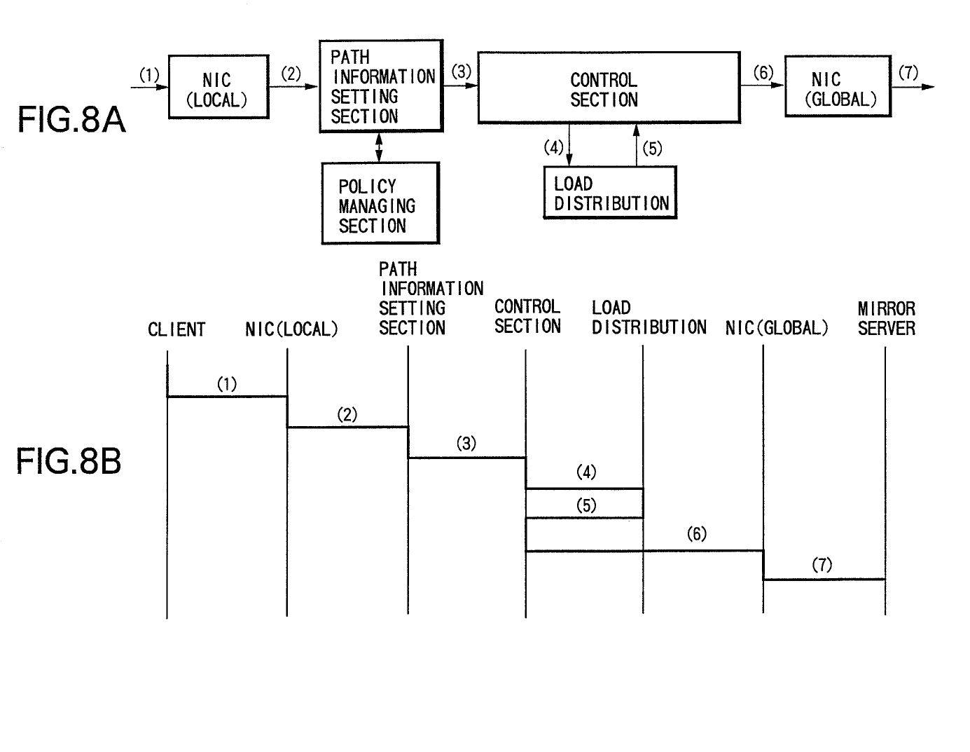

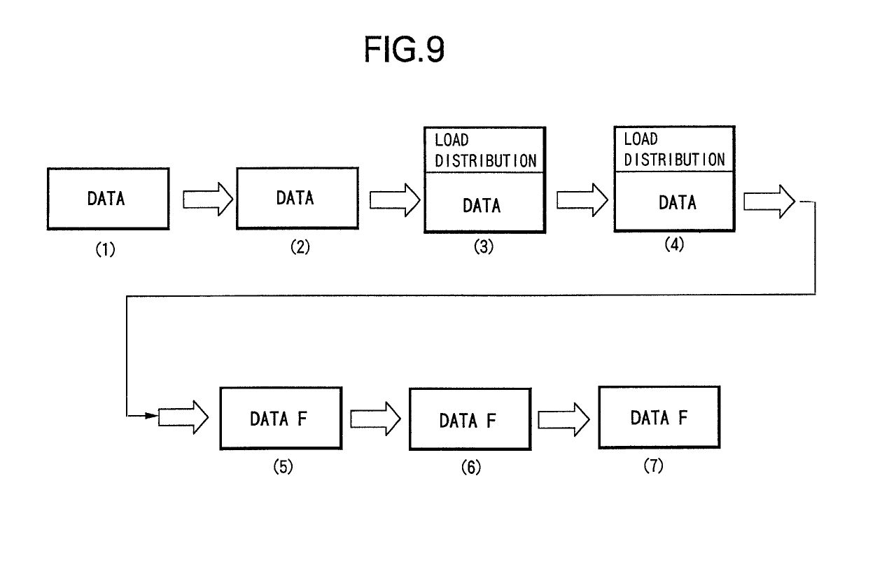

In a first example as shown in FIG. 8 and FIG. 9, the explanation will be made on process contents to be executed at the network server 10, when an access demand from the client 22 to the mirror server 24 in the LAN 20 is sent. (1)˜(7) in FIG. 8 and FIG. 9 show process paths as well as contents of the frame data transmitted through the process paths (the same hereinafter).

The access demand from the client 22 to the mirror server 24 is transmitted to the path information setting section 10C as the packet data through NIC (local) 10A ((1) and (2)).

At the path information setting section 10C that has received the packet data, the table (see FIG. 2) managed by the policy managing section 10D is referred to, and the path information (load distribution 10F) corresponding to the access demand to mirror server 24 is obtained. When the path information is obtained, a frame data in which the path information is added to the packet information is created, and the thus created frame data is sent to the control section 10E (3).

At the control section 10E that has received the frame data, the added path information is analyzed and the frame data is sent to the load distribution 10F as the module to sent the frame data (4).

At the load distribution 10F that has received the frame data, an optimal mirror server 24 to be accessed is specified corresponding to processing situations of the mirror servers 24. When the mirror server 24 is specified, the load distribution 10F is deleted from the path information in the frame data, and the thus deleted load distribution 10F is sent (returned) to the control section 10E (5).

At the control section 10E that has received the frame data from which the load distribution 10F is deleted, the path information is analyzed again, and it is judged that there is no module to send the frame data, and the packet data is sent to NIC (global) 10B (6).

At NIC (global) 10B that has received the packet data, the packet data is sent to the optimal mirror server 24 to be accessed (7).

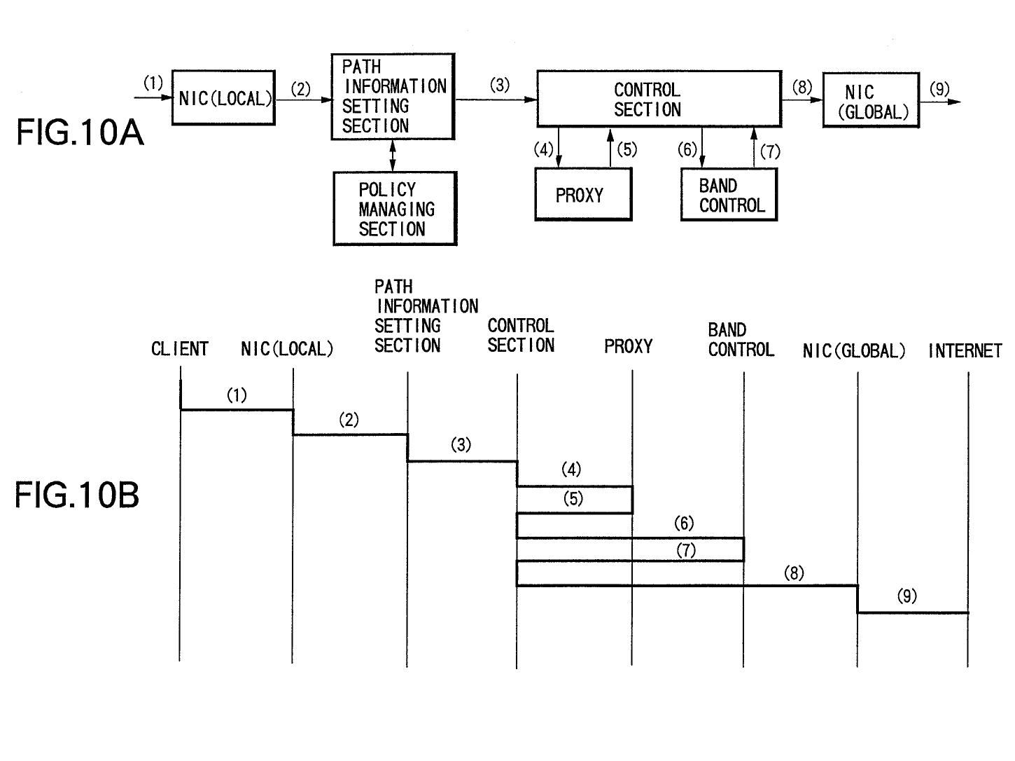

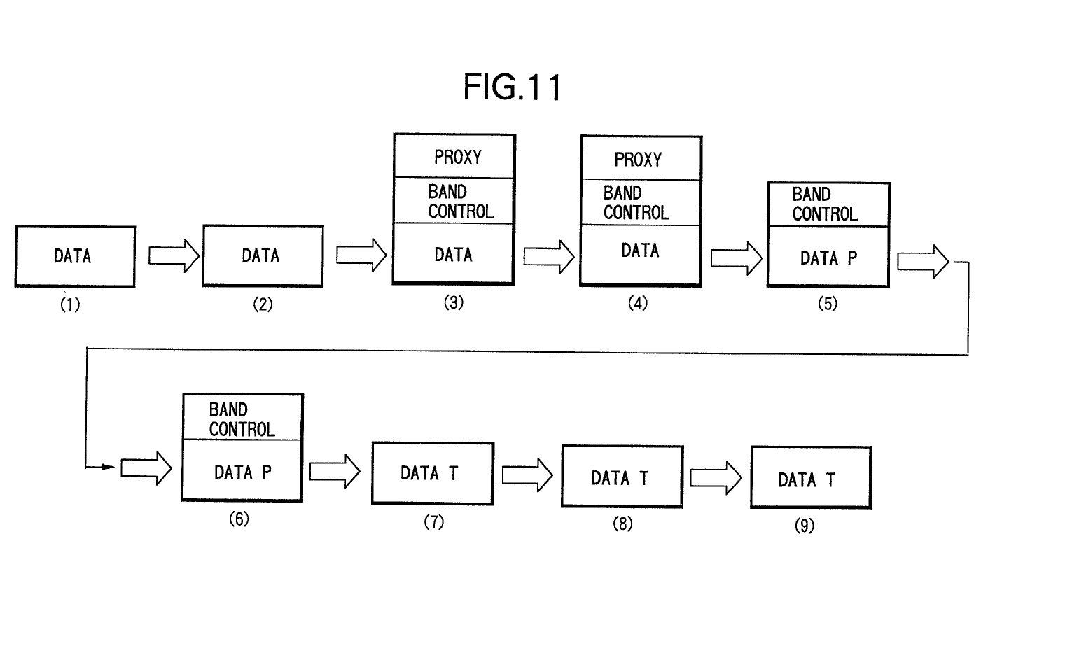

In a second example as shown in FIG. 10 and FIG. 11, the explanation will be made on process contents to be executed at the network server 10, when an access demand from the client 22 to Internet 30 is made.

The access demand from the client 22 to Internet 30 is transmitted to the path information setting section 10C through NIC (local) 10A as the packet data ((1) and (2)). At the path information setting section 10C that has received the packet data, a frame data to which a path information (proxy 10J→band control 10G) corresponding to the access demand to Internet 30 is added, is created, and the thus created frame data is sent to the control section 10E (3). At the control section 10E that has received the frame data, the frame data is sent to the proxy 10J in response to an analysis result of the path information (4). At the proxy 10J that has received the frame data, a conversion process between a local IP address and a global IP address is executed, and after the proxy 10J is deleted from the path information in the frame data, the thus deleted proxy 10J is sent (returned) to the control section 10E (5).

At the control section 10E that has received the frame data from which the proxy 10J is deleted, the frame data is sent to the band control 10G corresponding to an analysis result of the path information (6). At the band control 10G that has received the frame data, a control processing of a network band is executed, and after the band control 10G is deleted from the path information in the frame data, the thus deleted band control 10G is sent (returned) to the control section 10E (7).

At the control section 10E that has received the frame data from which the band control 10G is deleted, it is judged that there is no module to send the frame data corresponding to an analysis result of the path information, and the packet data is sent to NIC (global) 10B (8). At NIC (global) 10B that has received the packet data, the packet data is sent to Internet 30 (9).

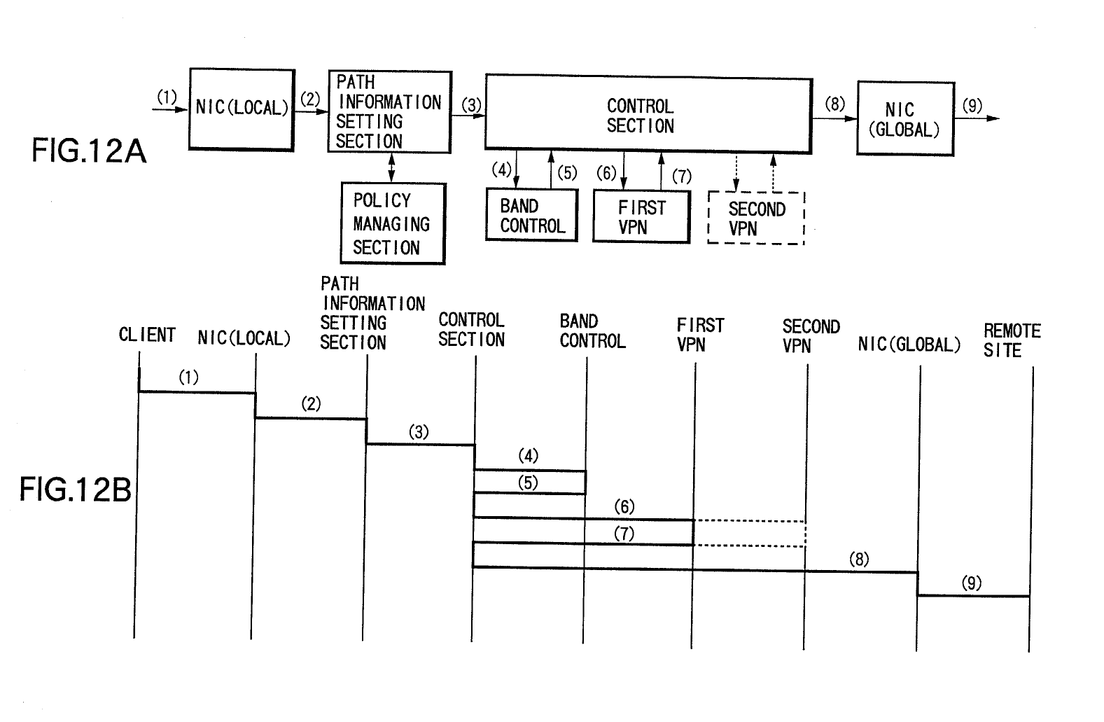

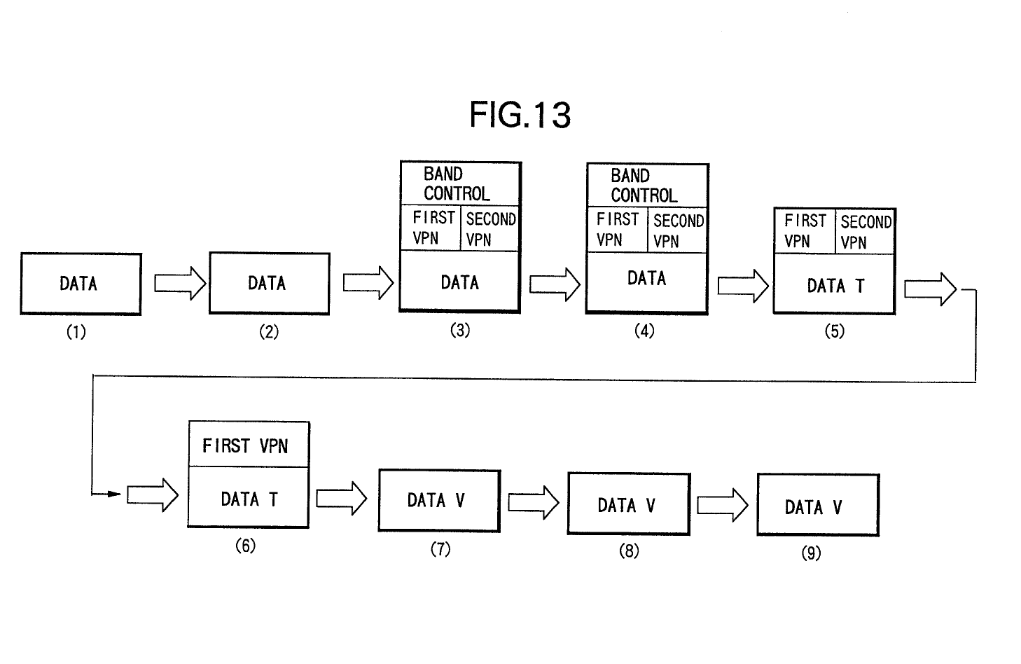

In a third example as shown in FIG. 12 and FIG. 13, the explanation will be made on process contents to be executed at the network server 10, when a connection demand from the client 22 to the remote site 40 is made.

The connection demand from the client 22 to the remote site 40 is transmitted to the path information setting section 10C as the packet data through NIC (local) 10A ((1) and (2)). At the path information setting section 10C that has received the packet data, a frame data to which a path information (band control 10G→first VPN 10H and second VPN 10I) corresponding to the connection demand to the remote site 40 is added, is created, and the thus created frame data is sent to the control section 10E (3). Here, the first VPN 10H and the second VPN 10I positioned in the same hierarchy do not require the process order, and this means that either of the first VPN 10H and the second VPN 10I may perform the processing of the frame data first. At the control section 10E that has received the frame data, the frame data is sent to the band control 10G corresponding to an analysis result of the path information (4). At the band control 10G that has received the frame data, the control processing of the network band is executed and after the band control 10G is deleted from the path information in the frame data, the thus deleted band control 10G is sent (returned) to the control section 10E (5).

At the control section 10E that has received the frame data from which the band control 10G is deleted, the frame data is sent to the first VPN 10H, corresponding to, for example, the round robin, the priority order or the processing situation (load distribution), as the module to send the frame data corresponding to an analysis result of the path information (6). At this time, since it is required that the VPN processing may be executed only one time, the second VPN 10I is deleted from the path information in the frame data. At the first VPN 10H that has received the frame data, the traffic processing to VPN is executed and after the first VPN 10H is deleted from the path information in the frame data, the thus deleted first VPN 10H is sent (returned) to the control section 10E (7).

The second VPN 10I which does not require the processing is not limited to be deleted at the control section 10E but may be deleted at a module (specifically, the first VPN 10H). Namely, the path information not requiring the data processing at a module may be deleted at the control section 10E or the modules 10F to 10J, which can judge that the data processing is not necessary. Further, in the present example, the path information is deleted, but the path information may be added or modified at the need arises.

At the control section 10E that has received the frame data from which the first VPN 10H is deleted, it is judged that there is not a module to send the frame data corresponding to an analysis result of the path information, and the packet data is sent to NIC (global) 10B (8). At the NIC (global) 10B that has received the packet data, the packet data is sent to the remote site 40 (9).

According to the first to third examples as explained above, the process path set at the path information setting section 10C is dynamically modified at the control section 10E or the modules 10F to 10J. Accordingly, for the data which does not require the process order, a bottleneck can be avoided to improve the processing power by, for example, giving priority to the processing in the module with less load corresponding to the processing situation of each of the various modules included in the process paths. Moreover, for example, even when a new module is added for strengthening a module function, since a process path is added to the added module at the need arises, the modification of the process path can be easily made. Further, when a process path to a module not requiring the data processing is included, since the process path to this module is deleted, a passage to a module that does not influence a data processing result at all is avoided. From this standpoint, the processing power can also be improved.

In the present embodiment, the data to be processed and the path information are integrated, but the path information not integrated with the data to be processed may be used when transferring the data to be processed. In this case, the path information as well as the data to be processed are sent from the path information setting section 10C to the control section 10E.

When a program performing these functions is stored in a computer readable record medium such as a magnetic tape, a magnetic disc, a magnetic drum, an IC card, a CD-ROM, a DVD-ROM and the like, the data processing program according to the present invention can be distributed in the market. A person who obtained such a record medium can easily construct a data processing apparatus according to the present invention using a general computer.

When the data processing program according to the present invention is recorded on a server connected with Internet, the data processing apparatus according to the present invention can easily be constructed by downloading this program through an electrical communication line.

What is claimed:

1. A data processing program for realizing on a computer: a process path setting function for setting a process path for various modules; a control function for transferring data to be processed among said various modules based on the process paths set by said process path setting function; and a process path modifying function for dynamically modifying the process paths set by said process path setting function at the need arises.

2. A data processing program according to claim 1, wherein
said process path modifying function adds a module necessary for the data processing in said various modules.

3. A data processing program according to claim 1, wherein
said process path modifying function deletes a module that has become unnecessary as a result of data processing in said various modules.

4. A data processing program according to claim 1, wherein
said process path modifying function is provided in said modules or in said control function.

5. A data processing program according to claim 1, wherein
said process path setting function sets the process paths for said various modules by referring to a table set with the process paths corresponding to a process content of the data to be processed.

6. A data processing program according to claim 1, wherein
said process path setting function is capable of selectively performing the path designation for designating the process order of said module, the processing section designation for designating said module only, and the compound designation combining said path designation and said processing section designation

7. A computer readable recording medium recorded with a data processing program for recording on a computer: a process path setting function for setting a process path for various modules; a control function for transferring data to be processed among said various modules based on the process paths set by said process path setting function; and a process path modifying function for dynamically modifying the process paths set by said process path setting function at the need arises.

8. A computer readable recording medium recorded with a data processing program according to claim 7, wherein
said process path modifying function adds a module necessary for the data processing in said various modules or deletes a module that has become unnecessary as a result of data processing in said various modules.

9. A data processing apparatus comprising: process path setting means for setting a process path for various modules; control means for transferring data to be processed among said various modules based on the process paths set by said process path setting means; and process path modifying means for dynamically modifying the process paths set by said process path setting means at the need arises.

10. A data processing apparatus according to claim 9, wherein
said process path modifying means adds a module necessary for the data processing in said various modules or deletes a module that has become unnecessary as a result of data processing in said various modules.
